(19) United States
(12) Patent Application Publication
(10) Pub. No.: US 2007/0201707 A1
(43) Pub. Date: Aug. 30, 2007

(54) Acoustic Effecter

(76) Inventors: Yukihiro Ando, Nagano (JP); Fumio Denda, Kanagawa (JP)

Correspondence Address: Christopher J Fildes;Fildes & Outland, Suite 2, 20916 Mack Avenue, Grosse Pointe Woods, MI, 48236, US

(21) Appl. No.: 11/587,072

(22) PCT Filed: May 17, 2005
(86) PCT No.: PCT/JP05/08999

§ 371 Date: Oct. 20, 2006

(30) Foreign Application Priority Data
May 20, 2004 (JP) 2004-150111

(51) Int. Cl. H04R 25/00

(52) U.S. Cl. 381/150

(57) ABSTRACT

There is provided an acoustic effecter capable of compensating deterioration of an audio source signal in a transmission path and obtaining an audio having an emphasized transient response. The acoustic effecter superimposes reflection energy generated by impedance mismatch of the transmission path on the acoustic signal to be transmitted or emits the reflection energy into the air and superimposes it on the audio output. A terminating element (12) generating signal reflection via a terminating transmission path (13) is connected in parallel to the output terminal or the input terminal (112) of the transmission path (30).

### TECHNICAL FIELD

The present invention relates to an electro-acoustic transducer, and relates to an acoustic effecter which superimposes reflection energy generated by impedance mismatch of a transmission path on an acoustic signal to be transmitted or emits the reflection energy into the air and superimposes it on an audio output to enhance impulse responsiveness of reproduced sound or recorded sound.

### BACKGROUND ART

In a conventional electro-acoustic signal transmission path and an electro-acoustic transducer (speaker), in order to reduce signal transmission loss and acoustic transduction loss, a line material with high purity, a covering material and a jacket material with a small relative dielectric constant are mainly used, but in this case, reduction in quality of reproduced sound due to deterioration of a signal cannot be eliminated though the transmission loss and the acoustic transduction loss can be reduced, and the reproduced sound is far from natural sound and insufficient. In the electro-acoustic transducer, transduction efficiency is low, acoustic transduction of a rising part of sound (impulse response) that is a main component characterizing the sound is lost, and information which the signal source has cannot be transduced into audible energy.

Further, in the transmission path from the signal source to the electro-acoustic transducer, there arises the phenomenon in which a steep rising and lowering parts (impulse response) including high-frequency components deteriorate due to a filter constructed by electrostatic capacity between lines and an inductor. This means that the signal from the signal source including high-frequency components deteriorates at the point of time when it reaches the electro-acoustic transducer, and becomes an obstacle on reproducing the signal from the signal source with high fidelity. Namely, the sound of a piano or the like is loaded with the information characterizing each sound in the initial rising part of the sound. If the signal of the rising part deteriorates, it becomes difficult to discriminate the instrument, and therefore, deterioration of the signal in the transmission path (especially, slowdown of a steep rising part) causes a disadvantage in reproduction of sound.

Accordingly, it is desired to compensate deterioration of rising and lowering of a signal and give the signal closer to the signal outputted from the signal source to the electro-acoustic transducer, namely, the speaker, or superimpose the signal on the audio output in the air.

In order to solve the problem, there is proposed a resonate type tweeter in which an ultra-high frequency sound reproducing speaker unit and an ultra-low capacitance capacitor as a high pass filter are incorporated into a resonance barrel. In this resonate type tweeter, the ultra-high frequency sound reproducing speaker unit reproduces an audio signal outside an audible frequency band which is passed through the ultra low capacitance capacitor, the audio output resonated and amplified by the resonance barrel and the audio output of the conventional speaker system are both outputted to compensate the insufficient audio output in the ultra high-frequency sound range in the conventional speaker system and perform reproduction faithfully to the sound source signal (see, for example, Patent Document 1).

[Patent Document 1]: Japanese Patent Application No. 2003-295691

### DISCLOSURE OF THE INVENTION

### Problem to be Solved by the Invention

In transmission of energy, in order to suppress energy loss due to reflection of a transmission path, matching of impedance is performed. This makes it possible to reduce loss of the transmission path, but cannot respond to deterioration of the signal by the transmission path.

The present invention has an object to provide an acoustic effecter which reflects a steep rising part of a sound source signal inputted into a transmission path and superimposes it on the rising part of the sound source signal, compensates deterioration of the sound source signal in the transmission path and is capable of obtaining an audio having an emphasized transient response. Further, the present invention has an object to provide a mechanism which enhances impulse responsiveness of an acoustic signal and transduces information which a source signal has into audible energy.

### MEANS FOR SOLVING THE PROBLEM

The present invention solves the above described problem by compensating deterioration of a rising part of an audio signal by effectively utilizing reflection energy by impedance mismatch.

Further, the present invention provides the mechanism in which another electro-acoustic signal transmission path (hereinafter, called a terminal signal transmission path) other than the conventional electro-acoustic signal transmission path is disposed, a terminating element which is opened or short-circuited is connected to the terminating end of the terminal signal transmission path, the starting point is connected in parallel with the terminating end of the conventional electro-acoustic signal transmission path, an electro-acoustic signal is reflected at the terminating element to generate inaudible energy, the energy is superimposed on an acoustic signal transduced by the electro-acoustic transducer, impulse responsiveness of the acoustic signal is enhanced, and information the source signal has is transduced into audible energy. In the specification, “superimposing” means both superimposing reflection energy released into the air with the terminating element and the reproduced sound of a speaker in the air, and superimposing the reflection energy generating at the terminating element on the original signal to assimilate it in the speaker body (transducing it into audible energy and inaudible energy).

All the above described terminating signal transmission path and terminating element have a structure having large impedance in a high frequency region, reflection of voltage and current occurs to the tip end portions, and the present invention solves the above described problem by assimilating the reflection energy inside of the electro-acoustic transducer, or superimposing it on the audio output in the air.

Further, in the present invention, in acoustic reproduction and collection of sound, the terminating signal transmission path and the terminating element are connected in parallel to the terminal of the electro-acoustic transducer.

Namely, the present invention is, in an electro-acoustic transducer, characterized in that a terminating element causing reflection of a signal is connected to an inside of a signal transmission path (between an amplifier and a speaker).

The present invention is, in the above described acoustic effecter, characterized in that the terminating element has the other end portion opened or short-circuited. Further, the present invention is, in the above described acoustic effecter, characterized in that the terminating element is sealed in a substance or placed in the air.

The present invention is characterized in that the acoustic effecter is means for transducing sound into an electric signal, or transducing an electric signal into sound. Namely, the present invention is characterized in that an output terminal or an input terminal of the acoustic effecter is an input terminal of a speaker or an output terminal of an amplifier, or an input terminal of a headphone, or an input terminal of an earphone, and the above described terminating element is connected in parallel to the terminal or the inside of a signal transmission path. Further, the present invention is characterized in that the output terminal or the input terminal of the acoustic effecter is an output terminal of the microphone unit, and the terminating element is connected in parallel to the terminal or the inside of the signal transmission path.

The present invention is characterized in that the terminating element has two transmission paths disposed in parallel, and their terminating ends opened. Further, the present invention is characterized in that the terminating element has tip ends of the transmission path formed into planer shapes to be opposed to each other in parallel, and a dielectric substance disposed therebetween. Further, the present invention is characterized in that the terminating element has two transmission paths disposed in parallel, and their terminating ends are short-circuited.

### EFFECT OF THE INVENTION

According to the present invention, the electric reflection signal energy of the electric transmission path is utilized, and the reflection signal is superimposed on the original signal, whereby the rising part of the signal can be emphasized, and delicateness of an audio can be obtained. Further, by emphasizing rising of the audio waveform in the ultra-high frequency region, clarity of an audio can be realized. Namely, vibration by undulation and energy is obtained by excessively keeping incompatibility of impedance of a transmission path, and as the total result, the acoustical environment in which a wave front of an audio is felt strong can be formed.

### BRIEF DESCRIPTION OF THE DRAWINGS

FIG. 1 is a view explaining a construction of an electro-acoustic transducer according to a first embodiment of the present invention;

FIG. 2 is a view explaining an electro-acoustic signal inputted into the electro-acoustic transducer in FIG. 1;

FIG. 3 is a view explaining a structure of a terminating element of the present invention;

FIG. 4 is a view explaining a construction of an electro-acoustic transducer according to a second embodiment of the present invention;

FIG. 5 is a view explaining a third embodiment in which the terminating element of the present invention is applied to a headphone or a dynamic microphone; and

FIG. 6 is a view explaining a fourth embodiment in which the terminating element of the present invention is applied to a capacitor microphone.

### DESCRIPTION OF SYMBOLS

11 speaker
111 voice coil
112 input terminal
12 terminating element
121 electrode
122 insulating material sheet
13 terminating transmission path
131 electric wire
113 insulating material
20 amplifier
21 sound source signal
30 electric acoustic signal transmission path
150 microphone unit
151 power supply
152 resistor
153 capacitor
154 output terminal

### MODE FOR CARRYING OUT THE INVENTION

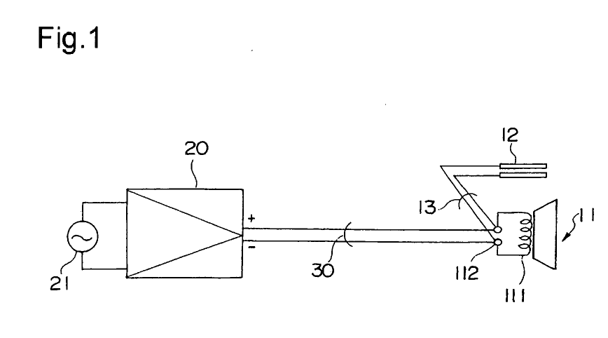

Embodiments of the present invention will now be described. By using FIG. 1, an example of a construction of an electro-acoustic transducer according to a first embodiment of the present invention will be described.

An electro-acoustic transducer 1 is constructed by having a speaker 11, a terminating element 12, and a terminating transmission path 13. The speaker 11 has a coil 111 and an input terminal 112. A starting point of the terminating transmission path 13 is connected to the input terminal 112, and an end point of an electro-acoustic signal transmission path 30 is connected to the input terminal 112 to be connected to an amplifier 20 connected to a sound source signal 21. The terminating element 12 is connected to the end point of the terminating transmission path 13.

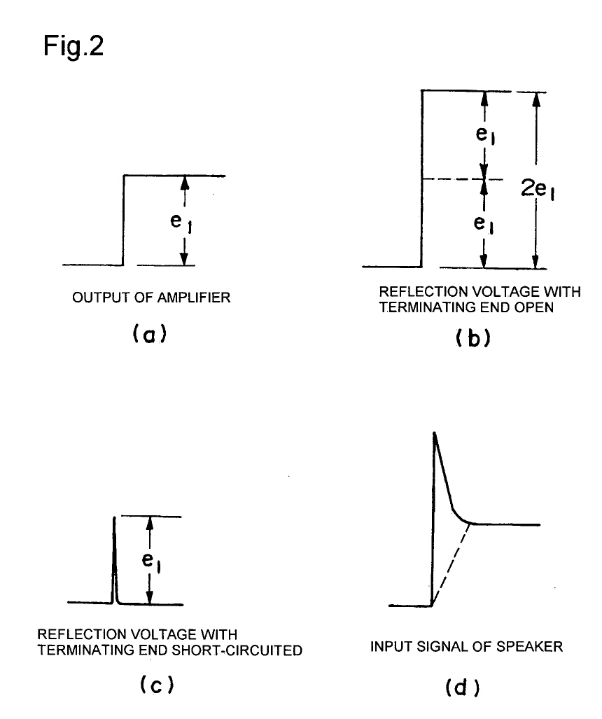

As shown in FIG. 2, the terminating element 12 is an element with its terminating end of the terminating element 12 open, reflection voltage becomes 2e₁ (FIG. 2(b)) which is twice as high as an output signal (FIG. 2(a)) voltage e₁ of the amplifier, and when the terminating element 12 is an element with its terminating end of the terminal element 12 short-circuited, the reflection voltage becomes a differential value of the output voltage e₁ of the amplifier (FIG. 2(c)). A signal which is reflected at the terminating element 12 connected to the terminating transmission path 13 is superimposed on the signal outputted from the amplifier 20, deterioration of a rising part is compensated, and the input signal of the speaker 11 becomes a signal (FIG. 2(d)) with the rising part emphasized. In the terminating element 12, part of the signal is emitted into the air and superimposed on a speaker output sound. When the terminating element is connected to a speaker terminal, the reflection voltage is assimilated and superimposed inside the speaker.

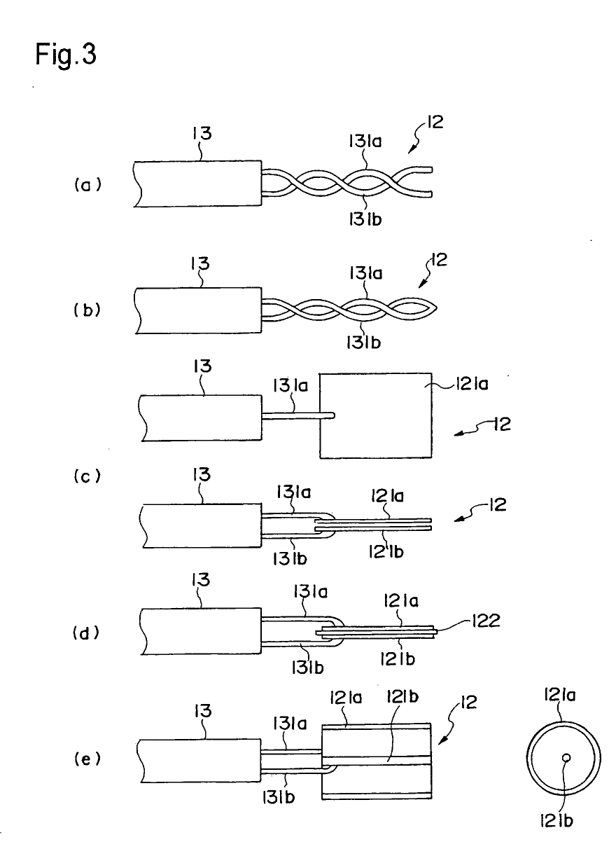

The terminating element 12 is constructed by, for example, two electric wires which are respectively connected to the terminating transmission path 13, and are constructed by opening or short-circuiting their terminating ends. The terminating element 12 in the first shape shown in FIG. 3(a) is constructed by stranding electric wires 131a and 131b of the terminating transmission path 13 and making their tip ends open. The electric wires 131a and 131b are disposed so as not to be in contact with each other. The terminating element 12 in the second shape shown in FIG. 3(b) is constructed by stranding the electric wires 131a and 131b of the terminating transmission path 13 and short-circuiting their tip ends. The electric wires 131a and 131b are disposed so as not to be in contact with each other except at the short-circuited tip end portions. The terminating element 12 in the third shape shown in FIG. 3C is constructed by connecting electrodes 121a and 121b disposed in parallel with a very small space kept therebetween to the tip ends of the electric wires 131a and 131b of the terminating transmission path 13. The electrodes 121a and 121b are disposed so as not to be in contact with each other, and a dielectric substance can be disposed between the electrodes. The upper view of FIG. 3(c) is a plane view and the lower view is a side view. The terminating element 12 in the fourth shape shown in FIG. 3(d) is constructed by forming the electrodes 121a and 121b made of conductors on a front and back surfaces of a sheet-shaped insulator 122 by metallizing plating, vapor deposition, bonding or the like and connecting the electric wires 131a and 131b of the terminating transmission path 13 to them, respectively. The terminating element 12 in the fifth shape shown in FIG. 3(e) is constructed by disposing the linear electrode 121b connected to the electric wire 131b in the center of the cylindrical electrode 121a connected to the electric wire 131a of the terminating transmission path 13. The electrode 121a and the electrode 121b are disposed so as not to be in contact with each other. In FIG. 3(a) or FIG. 3(b), by stranding the terminating transmission path 13, the same effect as the terminating element can be obtained without separately providing the terminating element 12.

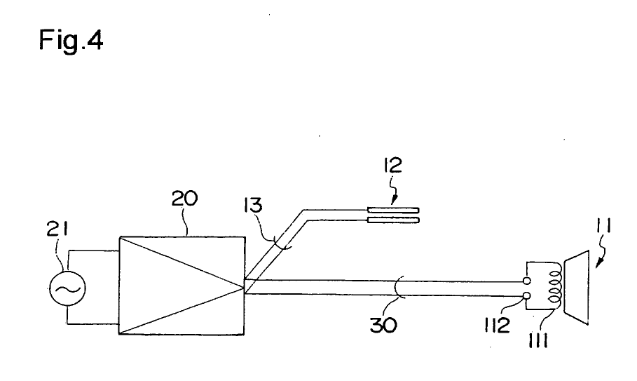

By using FIG. 4, a construction of an electro-acoustic transducer according to a second embodiment of the present invention will be described. In this embodiment, the electro-acoustic transducer 1 is constructed by the speaker 11 having the coil 111 and the input terminal 112, the electro-acoustic signal transmission path 30 connected to the input terminal 112, and the terminating element 12 connected in parallel to the starting point (the output terminal of the amplifier 20 connected to the sound source signal 21) of the electric signal transmission path 30 via the terminating transmission path 13.

In this embodiment, a reflection signal from the terminating element 12 is superimposed on the output signal of the amplifier 20, and a signal inputted into the speaker 11 becomes a signal of which rising part is emphasized. In the first embodiment or the second embodiment, the terminating element 12 is connected to the input terminal or the output terminal 112 of the transmission path 30, but the spot to which the terminating element 12 is connected is not limited to these two spots, and can be connected to any spot in the intermediate portion of the transmission path 30. The best mode is the spot of the first embodiment.

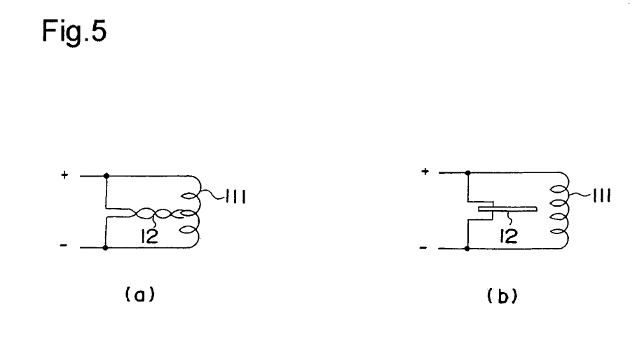

By using FIG. 5, a third embodiment in which the terminating element is applied to a headphone or dynamic microphone will be described. FIG. 5(a) shows a circuit in which the terminating element 12 shown in FIG. 3(a) is connected in parallel to the voice coil 111, and FIG. 5(b) is a circuit in which the terminating element 12 shown in FIG. 3(d) is connected in parallel to the voice coil 111. In each of these examples, reflection from the terminating element 12 is superimposed on an input signal of the voice coil of the headphone or an output signal of the voice coil of the dynamic microphone, and the same effect as in the first embodiment and the second embodiment can be provided.

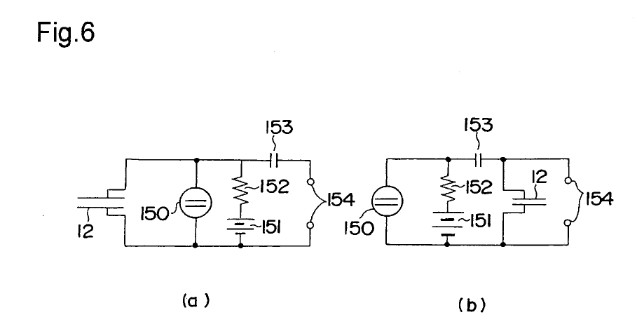

By using FIG. 6, a fourth embodiment in which the terminating element 12 is applied to a capacitor microphone will be described. The capacitor microphone has a series circuit of a power supply 151 and a resistor 152 connected in parallel with a microphone unit 150, and is connected to an output terminal via a capacitor 53. FIG. 6(a) shows a circuit in which the terminating element 12 is connected in parallel with the microphone unit 150, and FIG. 6(b) is a circuit in which the terminating element 12 is connected in parallel with an output terminal 154.

As above, in the present invention, in the electro-acoustic transducer, by connecting the terminating element in parallel with the input terminal or the output terminal of the coil via the terminating transmission path, or by connecting the terminating element in parallel with the output terminal of the amplifier via the terminating transmission path, reflection from the terminating element can be superimposed on the electro-acoustic signal, and the signal of which rising part of the electro-acoustic signal is emphasized can be obtained, thus making it possible to obtain an electro-acoustic signal with deterioration of the transmission path compensated.

1. An acoustic effecter, characterized in that a terminating element causing reflection of a signal is connected in parallel with a transmission path, and the other end portion of the terminating element is opened or short-circuited.

2. An acoustic effecter in which a terminating element causing reflection of a signal is connected in parallel with a transmission path and the other end portion of the terminating element is opened or short-circuited, characterized in that,
the terminating element is sealed in a substance or placed in the air.

3. The acoustic effecter according to claim 1, characterized in that
the acoustic effecter is means for transducing sound into an electric signal, or transducing an electric signal into sound.

4. The acoustic effecter according to claim 1, characterized in that
the acoustic effecter is means for transducing sound into an electric signal, or transducing an electric signal into sound.

5. The acoustic effecter according to claim 1, characterized in that
the terminating element is incorporated at an optional spot on the transmission path between an amplifier and acoustic apparatus.

6. The acoustic effecter according to claim 1, characterized in that
the terminating element is connected to an output terminal of a microphone unit.

7. The acoustic effecter according to claim 1, characterized in that the terminating element has two transmission paths disposed in parallel, and their terminating ends opened.

8. The acoustic effecter according to claim 1, characterized in that the terminating element has tip ends of the transmission path formed into planer shapes to be opposed to each other in parallel, and a dielectric substance disposed therebetween.

9. The acoustic effecter according to claim 1, characterized in that the terminating element has two transmission paths disposed in parallel, and their terminating ends short-circuited.
